(19) United States
(12) Patent Application Publication
(10) Pub. No.: US 2016/0269685 A1
(43) Pub. Date: Sep. 15, 2016

(54) VIDEO INTERACTION BETWEEN PHYSICAL LOCATIONS

(71) Applicant: ULTRADENT PRODUCTS, INC., South Jordan, UT (US)

(72) Inventors: Neil T. Jessop, Sandy, UT (US); Matthew Michael Fisher, Kaysville, UT (US)

(21) Appl. No.: 15/034,133

(22) PCT Filed: Nov. 24, 2014
(86) PCT No.: PCT/US2014/067181

§ 371 Date: May 3, 2016

Related U.S. Application Data
(60) Provisional application No. 61/909,636, filed on Nov. 27, 2013.

(51) Int. Cl. H04N 7/15; H04N 7/14; G06F 3/01

(52) U.S. Cl. CPC H04N 7/152; G06F 3/012; H04N 7/142

(57) ABSTRACT

Systems and methods for video interaction between physical locations are disclosed. The systems can include a first room having a plurality of video cameras and a second room having a plurality of motion detection cameras. A marker located in the second room can be detected by the plurality of motion detection cameras whereby location coordinates can be calculated for the marker. A relative position of the marker in the first room can be determined using the location coordinates. A video feed from the first room can be identified that provides a perspective of the first room based on the relative position of the marker and the video feed can be provided to a display located in the second room.

### BACKGROUND

Advances in communication technology allow people from all over the world to see and hear one another almost instantly. Using voice technology and video technology, meetings can be conducted between groups of people located in different geographical locations. For example, business associates in one location can communicate with counterparts in a geographically remote location by using a video camera and a microphone and sending voice data and video data captured by the video camera and microphone over a computer network. The voice data and the video data can be received by a computer and the video data can be displayed on a screen and the voice data can be heard using a speaker.

Because an option of conducting a meeting over a computer network is now available, businesses can save significant amounts of time and money. Prior to the ability to conduct a meeting over a network, management, sales persons and other employees of a business traveled to a counterpart location, expending funds on airfare, rental cars and accommodations. These expenses can now be avoided by meeting with business associates using a computer network rather than traveling to a business associate's location.

### BRIEF DESCRIPTION OF THE DRAWINGS

Features and advantages of the present disclosure will be apparent from the following detailed description, taken in conjunction with the accompanying drawings, which together illustrate, by way of example, features of the invention.

FIG. 1 illustrates a diagram of an exemplary system for video interaction between two physical locations;

FIG. 2 illustrates a block diagram for an exemplary system that provides for video interaction between two physical locations;

FIG. 3 provides an exemplary diagram illustrating a meeting room having an array of video cameras that surround the perimeter of the meeting room;

FIG. 4 provides an exemplary diagram illustrating a meeting room that can be used to interact with a remote meeting room;

FIG. 5 provides an exemplary diagram illustrating a head mountable video display;

FIG. 6 is a flow diagram illustrating an exemplary method for video interaction between multiple physical locations; and

FIG. 7 provides an exemplary diagram illustrating a method for two-way interaction between two physical rooms.

Reference will now be made to the illustrated exemplary embodiments, and specific language will be used herein to describe the same. It will nevertheless be understood that no limitation of the scope of the invention is thereby intended.

### DETAILED DESCRIPTION

Before the present invention is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

As a preliminary matter, it is noted that much discussion is related herein to the business profession and conducting conference meetings. However, this is done for exemplary purposes only, as the systems and methods described herein are also applicable to other circumstances that would benefit from virtual interaction between two physical locations. For example, the systems and methods herein can be useful for personal communication between friends and family. Additionally, the systems and methods of the present disclosure can also be applicable to classroom teaching, where students who may not be present in a physical classroom can participate from another location and be provided with an experience as if the student where present in the physical classroom.

With this in mind, an initial overview of technology embodiments is provided below and then specific technology embodiments are described in further detail thereafter. This initial description is intended to provide a basic understanding of the technology, but is not intended to identify all features of the technology, nor is it intended to limit the scope of the claimed subject matter.

Although conducting a meeting over a computer network may enable participants to see and hear one another, participants viewing a display, such as a TV monitor, do not experience the meeting in a way that is similar to a face-to-face meeting where all participants are in the same room. Rather than speaking directly to one another, meeting participants may feel as though they are talking to a TV monitor or a speakerphone rather than to a live person. Additionally, in a case where a video camera may be stationary and may be directed toward a meeting participant's face, other participants may not see the body language (e.g., hand movements) and/or documents, items, visual demonstrations, etc. that a meeting participant may be using.

The present technology may enable a participant in a meeting conducted over a network to view other participants in a room at a remote location from a perspective that is similar to the participant's. In other words, a participant who may be in one conference room may be provided an experience of being in a conference room with the other participants who are at a remote location.

In accordance with embodiments of the present disclosure, systems and methods for providing video interaction between two physical locations are disclosed. The systems and methods, in one example, enable a participant in a meeting to view a remote meeting room and associated meeting participants from a perspective as though the participant where in the remote meeting room. It is noted that fields, such as medicine, teaching, business, or any other field where remote meetings may be used, the systems and methods of the present disclosure are applicable. Thus, as mentioned, discussion of business meetings are for exemplary purpose only and are not considered limiting except as specifically set forth in the claims.

That being understood, in order to provide a participant of a meeting conducted over a network an experience of being present in a remote meeting room, the participant may be provided with a head mountable display that enables the participant to view a video feed originating from two or more video cameras located in a remote meeting room. Video feeds from two or more video cameras can be used to create a virtual reality view of the remote meeting room. Location coordinates of the participant in the physical meeting room where the participant is located can be determined and the location coordinates can be correlated to a relative position in the remote meeting room. Based on the relative position in the remote meeting room, two or more video feeds can be used to create a virtual video feed that provides a view of the remote meeting from the relative position in the remote meeting room. The virtual video feed can then be provided to the head mountable display that the participant may be wearing. Thus, when viewing the video feed, the participant may be presented with a view of the remote meeting room from a perspective that correlates to where the participant is located in the physical meeting room.

In one example configuration, the head mountable display that a meeting participant may use to view a remote meeting room may include a display that displays a video feed using a transparent display providing a user with a head-up display (HUD). In another example configuration, the head mountable display may be a head mountable stereoscopic display that includes a right video display and a left video display that can create a near real-time stereoscopic video image. The use of a stereoscopic image enables stereopsis to be maintained, thereby allowing a user wearing the head mountable display to perceive depth in a meeting room. As used herein, the term “stereopsis” refers to the process in visual perception leading to the sensation of depth from viewing two optically separated projections of the world projected onto a person's eyes, respectively. This can be through the use of a head mountable pair of video screens, each with a different optical projection, or through optical separation of the two optical projections on a single video screen, as will be described hereinafter in greater detail.

In addition, the systems and methods disclosed herein enable members in all locations that may be participating in a meeting conducted over a network to view a remote meeting room. For instance, participants of a meeting who may be located in New York City can view members of the meeting located in Los Angeles, and those members of the meeting in Los Angeles can view the participants of the meeting in New York City. In other words, meeting participants in both locations can view the meeting room that is remote from the meeting room that a participant is physically located.

In accordance with one embodiment of the present disclosure, a system for video interaction between two physical locations can comprise a plurality of video cameras that can be configured to generate a video feed of a first room in a physical location. A plurality of motion detection cameras that can be located in a second room where the plurality of motion detection cameras can be configured to detect a marker located in the second room and provide coordinates of the marker's location in the second room. A head mountable display that can be worn by a meeting participant, where the head mountable display contains a video screen that can display a video feed received from a video camera in the first room. A computing device can be configured to receive a plurality of video feeds from the video cameras located in the first room and to receive coordinates for the marker from the plurality of motion detection cameras in the second room. The computing device can include a tracking module and a video module. The tracking module can be configured to determine a relative position of the marker in the second room in relation to a video camera located in the first room using the coordinates provided by the motion detection cameras. The video module can be configured to identify a video feed from a video camera in the first room that correlates to the relative position of the marker in the second room and provide the video feed to the head mountable display.

In another embodiment, a system for video interaction between two physical locations can further comprise of a computing device having a video module that can identify two video feeds from a plurality of video cameras in a first room that correlates to a relative position of a marker in a second room. By interpolating from the two video feeds, a virtual reality video feed can be rendered that provides a view of the first room from a perspective of the marker in the second room.

In other embodiments, a system for video interaction between two physical locations can comprise an array of video cameras configured for providing video camera feeds. An image processing module can be configured to i) receive video camera feeds from the array, ii) geometrically transform one or more of the video camera feeds to create a virtual camera feed; and iii) generate a stereoscopic video image from at least two camera feeds.

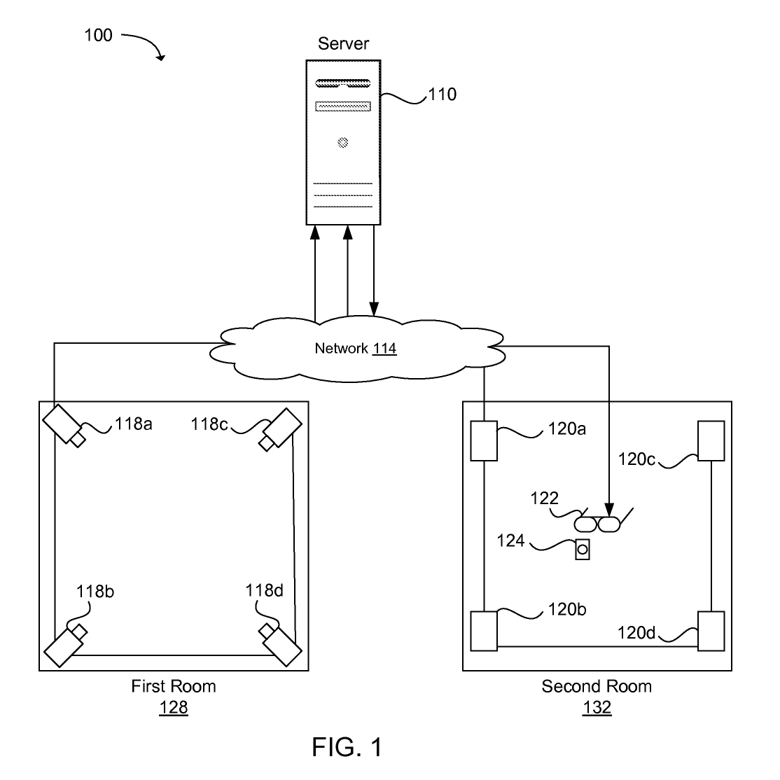

To further explain more detailed examples of the present disclosure, certain figures will be shown and described. Specifically, referring now to FIG. 1, an example system 100 for video interaction between two physical locations is shown. The system 100 may comprise a plurality of video cameras 118a-d that are spatially separated from one another around a perimeter of a first room 128. The plurality of video cameras 118a-d can be in communication with a server 110 by way of a network 114. The server 110 can be configured to receive video feeds from the plurality of video cameras 118a-d, where each video camera may be assigned a unique ID that enables the server 110 to identify a video camera 118a-d and the video camera's location within the first room 128.

The system 100 also includes a plurality of motion detection cameras 120a-d that may be spatially separated from one another around the perimeter of a second room 132. The plurality of motion detection cameras 120a-d may be in communication with the server 110 via the network 114. The plurality of motion detection cameras 120a-d can detect a marker 124 within the second room 132, calculate location coordinates for the marker 124 within the second room 132 and provide the identify and location coordinates of the marker 124 to the server 110. In one embodiment, the marker 124 may be an active marker that contains a light-emitting diode (LED) that is visible to the plurality of motion detection cameras 120a-d, or can be some other marker that is recognizable and trackable by the motion detection cameras 120a-d. The motion detection cameras 120a-d may locate and track an active marker within a room. An active marker may contain an LED that modulates at a unique frequency resulting in a unique digital ID for the active marker. Further, the LED may emit a visible light, or alternatively emit an infra-red light. In another embodiment, a marker 124 may be a passive marker wherein the marker may be coated with a retroreflective material that when illuminated by a light source, makes the passive marker visible to a motion detection camera 120a-d.

It is noted that the plurality of video cameras 118a-d and plurality of motion detectors 120a-d are shown as being present in four locations, respectively. It is noted that more or fewer cameras may be used, as may be desirable for a given application. For example, a conference room may have 5 to 50 cameras or 5 to 50 motion detectors, for example, or may include 2 or 3 cameras and/or 2 or 3 motion detectors.

Also included in the system 100 are one or more head mountable displays 122 that are in communication with the server 110. In one embodiment, the head mountable display 122 may include a single video display that may be positioned in front of a user's eye, or alternatively, the single video display can be sized and positioned so that the video display is in front of both of the user's eyes. In another embodiment, the head mountable display 122 may include a transparent display. A video feed can be projected onto the transparent display providing a user with a head-up display (HUD). And in yet another embodiment, the head mountable display 122 can include two video displays, one positioned in front of a user's right eye and another positioned in front of a user's left eye. A first video feed can be displayed on a right video display of the head mountable display 122 and the second video feed can be displayed on a left video display of the head mountable display 122. The right and left video displays can be projected onto a user's right and left eyes, respectively providing a stereoscopic video image. The stereoscopic video image provides a visual perception leading to the sensation of depth from the two slightly different video images projected onto the retinas of the two eyes. These embodiments can likewise be combined to form a stereoscopic image in an HUD, for example.

In one embodiment, the plurality of video cameras 118a-d may provide a video feeds to the server 110 and the server 110 can determine a video feed that most closely correlates to a coordinate location of a marker 124 in a room 132. The server can then provide the video feed to a head mountable display 122. In another embodiment, two video feeds may be identified from video cameras 118a-d located within a room 128 that most closely correlate to a coordinate location of a marker 124 and a virtual video feed can be generated from the two video feeds via interpolation. The resulting virtual video feed may be provided to a head mountable display 122 providing a user of the head mountable display 122 with a video image of a first room 128 from a perspective of the user's location in a second room 132. Additionally, two virtual video feeds can be generated, a first virtual video feed and a second virtual video feed, simulating a pupillary distance between the first virtual video feed and the second virtual video feed, with appropriate angles that are optically aligned with the pupillary distance, thus creating a virtual stereoscopic video image. The virtual stereoscopic video image can then be provided to a stereoscopic head mountable display 122. With respect to forming a virtual video feed, or a stereoscopic virtual video feed, it is noted that this is a generated image that uses real images collected from multiple cameras and interpolates data from these video feeds to generate a video feed that does not originate from a camera per se, but is generated based on information provided from multiple cameras, forming a virtual image that approximates the location of the marker within the second room. In this manner, the user in the second room can receive a virtual view that approximates his location and direction of viewing, as will be explained in greater detail hereinafter. It is noted that by using a single virtual image, the user can be a provided a two dimensional image for viewing, whereas if two virtual images are generated and provided to the user from two video monitors within a pair of glasses, a three-dimensional view of the first room can be provided to the user in the second room.

Thus, in further detail, the plurality of video cameras 118a-d can be adapted so that multiple pairs of video cameras are capable of generating a near real-time stereoscopic video image, each of the multiple pairs can comprise a first video camera configured to generate a first video feed of a first room 128 and a second video camera configured to generate a second video feed of the first room 128. For example, video camera 118a and 118b can be the first video camera and the second video camera in one instance, and video cameras 118c and 118d can be the first and second video cameras in a second instance. Furthermore, the video cameras need not be discrete pairs that are always used together. For example, video camera 118a and video camera 118c or 118d can make up a third pair of video cameras, and so forth. It is noted that the multiple pairs of video cameras can be spatially separated at a pupillary distance from one another, or can be positioned so that they are not necessarily a pupillary distance from one another, e.g., at a simulated pupillary distance with appropriate angles that are optically aligned with the pupillary distance, or spaced out of optical alignment with the pupillary distance with some signal correction being typical.

The plurality of video cameras 118a-d can be positioned in a one-dimensional array, such as in a straight line, e.g., 3, 4, 5, . . . 25 video cameras, etc., or a two-dimensional array, e.g., in an arrangement configured along an x- and y-axis, e.g., 3×3, 5×5, 4×5, 10×10, 20×20 cameras, or even in a three dimensional array, and so forth. Thus, in either embodiment, any two adjacent video cameras can be used as a first video camera and a second video camera. Alternatively, any two video cameras that may not be adjacent to one another might also be used to provide a video feed. Selection of video cameras 118a-d that provide video feeds can be based on a coordinate location of a marker 124 within a room 132. As can be appreciated, the system 100 described above can include placing video cameras 118a-d in both the first room 128 and second room 132, as well as motion detection cameras 120a-d in both the first room 128 and second room 132, thereby enabling participants in a meeting between the first room 128 and the second room 132 to see and interact with one another via head mountable displays 122.

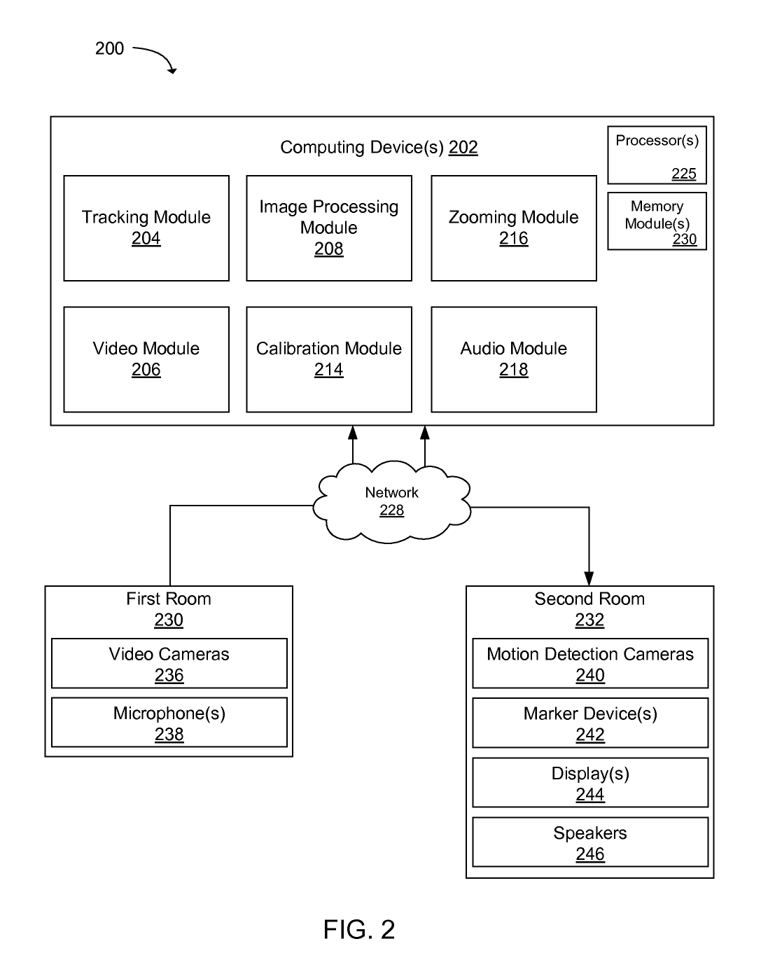

FIG. 2 illustrates an example of various components of a system 200 on which the present technology may be executed. The system 200 may include a computing device 202 having one or more processors 225, memory modules 230 and processing modules. In one embodiment, the computing device 202 may include a tracking module 204, video module 206, image processing module 208, calibration module 214, zooming module 216 as well as other services, processes, systems, engines, or functionality not discussed in detail herein. The computing device 202 may be in communication by way of a network 228 with various devices that may be found within room, such as a conference room where meetings may take place. For example, a first room 230 may be equipped with a number of video cameras 236 and one or more microphones 238. A second room 232 may be equipped with a number of motion detection cameras 240, marker devices 242, displays 244 and speakers 246.

The tracking module 204 may be configured to determine a relative position and/or direction of a marker device 242 located in a second room 232 in relation to the location of the marker device 242 in a first room 230. As a specific example, if the marker device 242 is located in the southern portion of the second room 232 and is facing north, then a relative position can be identified in the first room 230 that correlates to the southern location of the marker device 242 in the second room 232, namely a position in the first room 230 that is in the southern portion of the room facing north. A marker device 242 can be an active marker or a passive marker that a motion detection camera 240 is cable of detecting. For example, an active marker may contain an LED that may be visible to a motion detection camera 240. As the active marker is moved within the second room 232, motion detection cameras 240 can track the movement of the active marker and provide coordinates (i.e., x, y and z Cartesian coordinates and a direction) of the active marker to the tracking module 204. A relative position of the marker device 242 can be determined using the coordinates provided by the motion detection cameras 240 located in the second room 232. Data captured from the motion detection cameras 240 can be used to triangulate a 3-D position of a marker device 242 within the second room 232. For example, coordinate data captured by the motion detection cameras 240 can be received by the tracking module 204. Using the coordinate data, the tracking module 204 may determine a location of the marker device 242 in the second room 232 and then determine a relative location for the marker device 242 in the first room 230. In other words, a location of the marker device 242 in the second room 232 can be mapped to a corresponding location in the first room 230.

In another embodiment, the tracking module 204 can include image recognition software that can recognize a location or feature, such as a person's face, or other distinct characteristics. As the person moves within a second room 232, the tracking module 204 can track the person's movements and determine location coordinates for the person within the second room 232. Image recognition software can be programmed to recognize patterns. For example, software that includes facial recognition technology can be used with the systems of the present disclosure that is similar to that used with state of the art point and shoot digital cameras, e.g., boxes in digital display screens appear around faces to inform the user that a face of a subject has been recognized for focus or other purpose.

The video module 206 can be configured to identify a video feed from a video camera 236 located in a first room 230 that correlates to a relative position of a marker device 242 located in a second room 232 provided by the tracking module 204, and provide the video feed to a display 244 located in the second room 232. For example, the tracking module 204 can provide the video module 206 with a relative position of the marker device 242 in the second room 232 (i.e., x, y, z Cartesian coordinates and a directional coordinate) and identify a video feed that most closely provides a perspective to that of the relative position.

Alternatively, two video feeds from two video cameras 236 that are proximity located can be identified, where the video feeds provide a perspective that correlates to a relative position of a marker device 242. The video feeds can be provided to an image processing module 208 and geometrical transformations can be performed on the video feeds to create a virtual video feed that presents a perspective (i.e., a perspective other than that generated directly from the video feeds per se) that correlates to that of the marker device 242 in the second room 232. A virtual video feed can be multiplexed to a stereoscopic or 3-D signal for a stereoscopic display or sent to a head mounted display (e.g., right eye, left eye), to create a stereoscopic video. Hardware and software packages, including some state of the art packages, can be used or modified for this purpose. For example, NVIDIA has a video pipeline that allows users to take in multiple camera feeds, perform mathematical operations on them, and then output video feeds that have been transformed geometrically to create virtual perspectives that are an interpolation of actual video feeds. These video signals are typically in the Serial Digital Interface (SDI) format. Likewise, software used to perform such transformations is available as open source. OpenCV, OpenGL and CUDA can be used to manipulate the video feed. In order to create stereopsis, the images designed for the left and right eye or optically separated video feed to a single screen, whether virtual or real images are displayed, are typically separated by a pupillary distance or simulated pupillary distance, though this is not required. It is noted that the image processing module 208 shown in this example is for purposes of generating virtual camera feeds. However, any other type of image processing that may be beneficial for use in this embodiment or any other embodiment herein that would benefit from image processing can also include an image processing module 208.

The display 244 can comprise a video display that is configured to be placed on a user's head so that the video display is directly in front of the user's eyes. In one embodiment, the stereoscopic display can be a head mountable stereoscopic display with a right video display viewable by a person's right eye and a left video display viewable by a person's left eye. By displaying the first and second video feeds in the left and right video displays, a near real-time stereoscopic video image can be created. Alternatively, the stereoscopic display can be a single video screen wherein the first video feed and the second video feed are optically separated, e.g., shutter separation, polarization separation, color separation, etc. The stereoscopic display can be configured to allow a user to view the stereoscopic image with or without an external viewing device such as glasses. In one embodiment, a pair of appropriate glasses that work with shutter separation, polarization separation, color separation, or the like, can be used to allow the screen to be viewed in three-dimensions. Still further, the video display can comprise multiple video displays for multiple users to view the near real-time stereoscopic video image, such as participants of a meeting.

The calibration module 214 can be configured to calibrate and adjust horizontal alignment of a first video feed and a second video feed so that the pixels from a first video camera 236 are aligned with the pixels of a second video camera 236. When the display 244 is a head mountable stereoscopic display including a right video display and a left video display, proper alignment of the two images can be calibrated to the eyes of a user horizontally so that the image appears as natural as possible. The more unnatural an image appears, the more eye strain that can result. Horizontal alignment can also provide a clearer image when viewing the near real-time stereoscopic video image on a screen (with or without the assistance of viewing glasses). When the pixels are properly aligned, the image appears more natural and sharper than might be the case when the pixels are misaligned even slightly. Additional calibration can also be used to adjust the vertical alignment of the first video camera and the second video camera to a desired angle to provide stereopsis. The calibration module 214 can be configured to allow manual adjustment and/or automatic adjustment of horizontal and/or vertical alignment of the video feed pair.

Other uses for calibration can occur when the system 200 is first set up, or when multiple users are using the same equipment. In one example, the calibration module 214 can provide for calibration with multiple users. Thus, the system can be calibrated for a first user in a first mode and a second user in a second mode, and so forth. The system can be configured to switch between the first mode and the second mode automatically or manually based on whether the first user or the second user is using the system.

The zooming module 216 can be configured to provide a desired magnification of a video feed, including a near real-time stereoscopic video image. Because video cameras 236 may be affixed to the walls of a meeting room, the perspective of a video feed provided by a video camera may not be at a distance that correlates to that of a meeting participant's perspective, which may be located somewhere within the interior of the meeting room. The zooming module 216 can receive relative location coordinates for a marker device 242 and adjust the video feed by digitally zooming in or out so that the perspective of the video feed matches that of a meeting participant's. Alternatively, the zooming module 216 can control a video camera's lens, thereby zooming the lens in or out depending upon the perspective desired.

In one embodiment, the system 200 can contain an audio module 218 that can be configured to receive an audio feed from one or more microphones 238 that are located in a first room 230. In one example, a microphone 238 may be associated with a video camera 236 such that when the video camera is selected to provide a video feed, an audio feed from the microphone 238 associated with the video camera 236 is also selected. The audio feed can be provided to one or more speakers 246 that are located in a second room 232. In one embodiment, the speakers 246 can be distributed throughout the second room 232 enabling anyone within the room to hear the audio feed. In another embodiment, one or more speakers 246 can be integrated into a head mountable display so that a person wearing the head mountable display can hear the audio feed.

The various processes and/or other functionality contained on the computing device 202 may be executed on one or more processors 240 that are in communication with one or more memory modules 245 according to various examples. The computing device 202 may comprise, for example, of a server or any other system providing computing capability. Alternatively, a number of computing devices 202 may be employed that are arranged, for example, in one or more server banks or computer banks or other arrangements. For purposes of convenience, the computing device 202 is referred to in the singular. However, it is understood that a plurality of computing devices 202 may be employed in the various arrangements as described above.

The network 228 may include any useful computing network, including an intranet, the Internet, a local area network, a wide area network, a wireless data network, or any other such network or combination thereof. Components utilized for such a system may depend at least in part upon the type of network and/or environment selected. Communication over the network may be enabled by wired or wireless connections and combinations thereof.

FIG. 2 illustrates that certain processing modules may be discussed in connection with this technology and these processing modules may be implemented as computing services. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that are hosted in a server, cloud, grid or cluster computing system. An application program interface (API) may be provided for each module to enable a second module to send requests to and receive output from the first module. Such APIs may also allow third parties to interface with the module and make requests and receive output from the modules. While FIG. 2 illustrates an example of a system that may implement the techniques above, many other similar or different environments are possible. The example environments discussed and illustrated above are merely representative and not limiting.

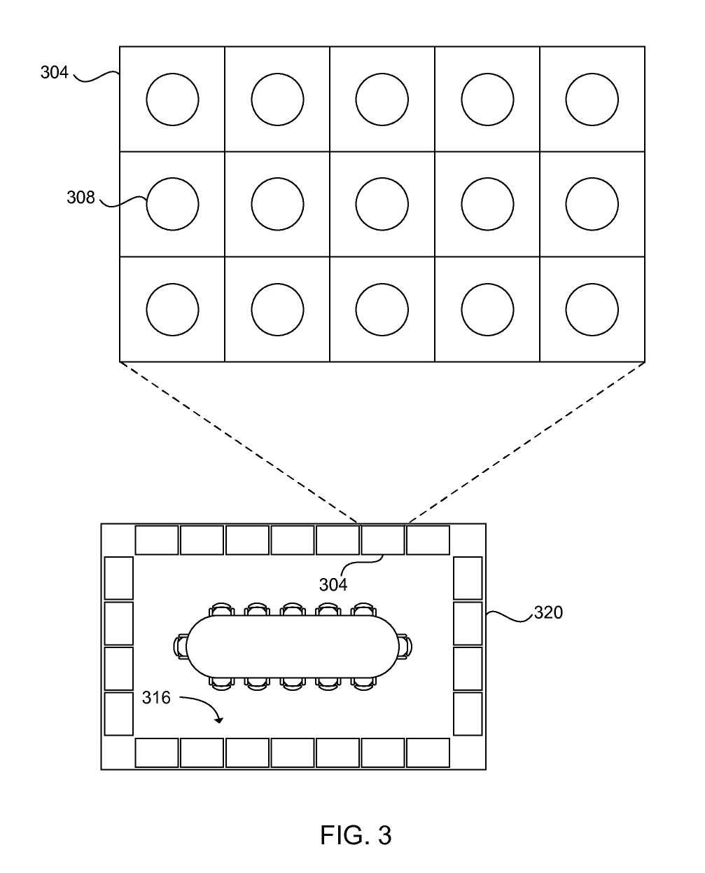

Moving now to FIG. 3, illustrated is an example of a meeting room 320 having an array of cameras 316 that surround a perimeter of the meeting room 320. The array of cameras 316 positioned around the perimeter of the meeting room 320 can be comprised of multiple sections of camera collections 304, where each camera collection 304 may contain a grid of video cameras (e.g., 2×2, 3×5, etc.). A video camera 308 within the camera collection 304 may be, in one example, a fixed video camera that provides a static video feed. In another example, a video camera 308 may include the ability to optically zoom in and out. And yet in another example, a video camera 308 can include an individual motor associated therewith to control a direction and/or focus of the video camera 308. The motor can be mechanically coupled to the video camera 308. For example, the motor may be connected through a series of gears and/or screws that allow the motor to be used to change an angle in which the video camera 308 is directed. Other types of mechanical couplings can also be used, as can be appreciated. Any type of mechanical coupling that enables the motor to update a direction in which the video camera 308 is pointed is considered to be within the scope of this embodiment.

The array of cameras 316 can be used to generate a virtual perspective of the meeting room 320 that can arise from the placement of the array of cameras 316 in a particular orientation in the Cartesian space of the meeting room 320. For example, the various video cameras can be positioned so that they are known relative to one another and relative to persons meeting in the meeting room 320. The position of persons within the meeting room 320 can also be known via tracking methods described herein, or as otherwise known in the art, via hardware (e.g., motion tracking technology or other tracking systems or modules) or via software.

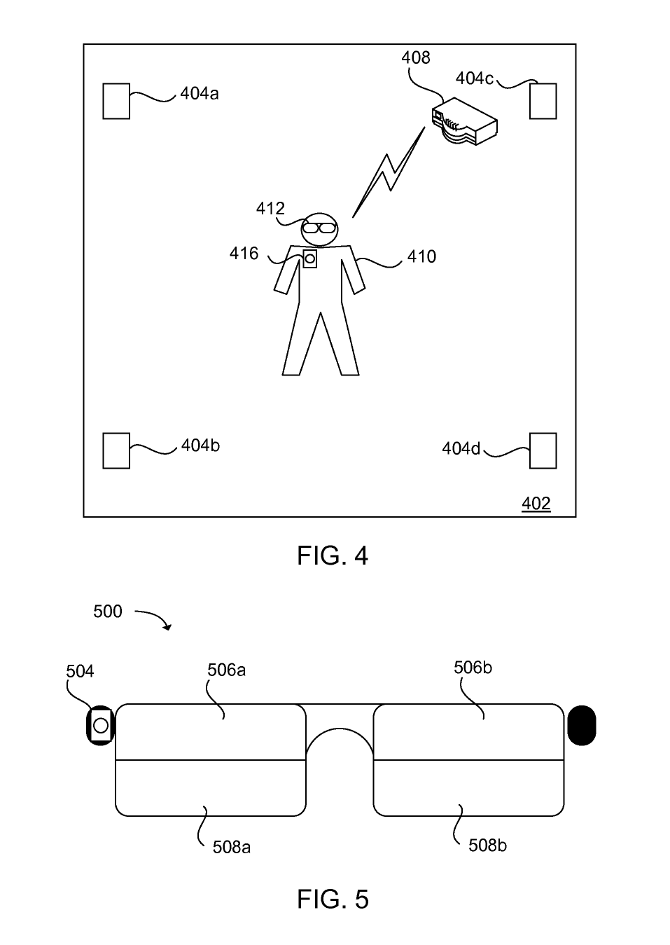

FIG. 4 is an example illustration of a meeting room 402 that includes a plurality of motion detection cameras 404a-c configured to detect a marker 416 within the meeting room 402. The plurality of detection cameras 404a-c can determine location coordinates for the marker 416 as described earlier and a video feed from a remote meeting room can be generated that substantially matches a relative position of the marker 416 in the remote room. The marker 416 can be attached to a meeting participant 410, whereby a location of the meeting participant 410 in the meeting room 402 can be tracked. The video feed can be provided to a head mountable display 412 that can be worn by the meeting participant 410. In one embodiment, the video feed can be sent to the head mountable display 412 via a wireless router 408 and a network. The network may be a wired or a wireless network such as the Internet, a local area network (LAN), wide area network (WAN), wireless local area network (WLAN), or wireless wide area network (WWAN). The WLAN may be implemented using a wireless standard such as Bluetooth or the Institute of Electronics and Electrical Engineers (IEEE) 802.11-2012, 802.11ac, 802.11ad standards, or other WLAN standards. The WWAN may be implemented using a wireless standard such as the IEEE 802.16-2009 or the third generation partnership project (3GPP) long term evolution (LTE) releases 8, 9, 10 or 11. Components utilized for such a system may depend at least in part upon the type of network and/or environment selected. Communication over the network may be enabled by wired or wireless connections and combinations thereof.

FIG. 5 is an example illustration of a head mountable video display 500 that can be used to view a video feed that can be generated from a remote room. In one embodiment, the head mountable video display 500 may include a marker 504 that can be integrated into the head mountable video display 500. For example, the marker may be integrated into the frame of the head mountable video display 500 making the marker 504 visible to a motion detection camera. Further, the marker 504 may be placed on the head mountable video display 500 so that the marker 504 is facing forward in relation to the head mountable video display 500. For example, the marker 504 can be placed on the front of the head mountable video display 500 so that when a user of the head mountable video display 500 faces a motion detection camera (i.e., the user's face is directed towards a motion detection camera), the marker 504 is visible to the motion detection camera. Thus, a motion detection camera can determine a direction coordinate for the marker 504. A direction coordinate can be used to identify a video camera that is directed in substantially the same direction. Further, a virtual video feed can be generated from a plurality of video feeds that provides a perspective that matches that of the direction coordinate.

In one embodiment, the head mountable video display 500 can be configured to provide a split field of view, with a bottom portion of the display providing separate high definition displays for the left and right eyes, and above the display, the user can view the environment unencumbered. Alternatively, the head mountable video display 500 can be configured in a split view where the bottom half provides the video image, and the top half of the display is substantially transparent to enable a user to view both natural surroundings while wearing the head mountable video display 500.

In another embodiment, a head mountable video display 500 can display a first video feed and a second video feed on a display system that optically separates the first video feed and the second video feed to create a near real-time stereoscopic video image. In one example, the first video feed can be displayed on a right video display of a head mountable video display 500 and the second video feed can be displayed on a left video display of the head mountable video display 500. The right and left video displays can be projected onto a user's right and left eyes, respectively. The stereoscopic video image provides a visual perception leading to the sensation of depth from the two slightly different video images projected onto the retinas of the two eyes.

Alternatively, a video display other than the head mountable video display 500 can be positioned to display the near real-time video feed as well. For instance, in one embodiment a first and a second video feed can be displayed on a single display screen with the respective video feeds being optically separated. Technologies for optical separation include shutter separation, polarization separation, and color separation. In one embodiment, a viewer or user can wear viewing glasses to view the separate images with stereopsis and depth perception. In other embodiments, multiple stereoscopic videos can be displayed, such as on multiple television screens. For instance, the stereoscopic image can be simultaneously displayed on a television screen, a projection display, and a head mountable stereoscopic video display.

Certain types of viewing glasses, such as LCD glasses using shutter separation, may be synchronized with the display screen to enable the viewer to view the optically separated near real-time stereoscopic video image. The optical separation of the video feeds provides a visual perception leading to the sensation of depth from the two slightly different video images projected onto the retinas of the two eyes, respectively, to create stereopsis.

In the embodiments described above, a video feed can be communicated to the head mountable video display 500 through wired communication cables, such as a digital visual interface (DVI) cable, a high-definition multimedia interface (HDMI) cable, component cables, and so forth. Alternatively, a video feed can be communicated wirelessly to the head mountable video display 500. For instance, a system that provides a wireless data link between the head mountable video display 500 and a server that provides the video feed.

Various standards which have been developed or are currently being developed to wirelessly communicate video feeds include the WirelessHD standard, the Wireless Gigabit Alliance (WiGig), the Wireless Home Digital Interface (WHDI), the Institute of Electronics and Electrical Engineers (IEEE) 802.15 standard, and the standards developed using ultrawideband (UWB) communication protocols. In another example, the IEEE 802.11 standard may be used to transmit the signal(s) from a server to a head mountable video display 500. One or more wireless standards that enable video feed information from a server to be transmitted to the head mountable video display 500 for display in near-real time can be used to eliminate the use of wires and free the user to move about more freely.

In another embodiment, video cameras and the head mountable video display 500 can be configured to display a relatively high resolution. For instance, the cameras and display can be configured to provide a 720P progressive video display with 1280 by 720 pixels (width by height), a 1080i interlaced video display with 1920×1080 pixels, or a 1080p progressive video display with 1920×1080 pixels. As processing power and digital memory continue to exponentially increase in accordance with Moore's Law, the cameras and display may provide an even higher resolution, such as 4320P progressive video display with 7680×4320 pixels. With higher resolution, an image can be magnified using software (digital zoom) to provide a digital magnification without substantially reducing the image quality. Thus, software alone may be used to provide a perspective to a wearer of the head mountable video display 500 of a remote meeting room.

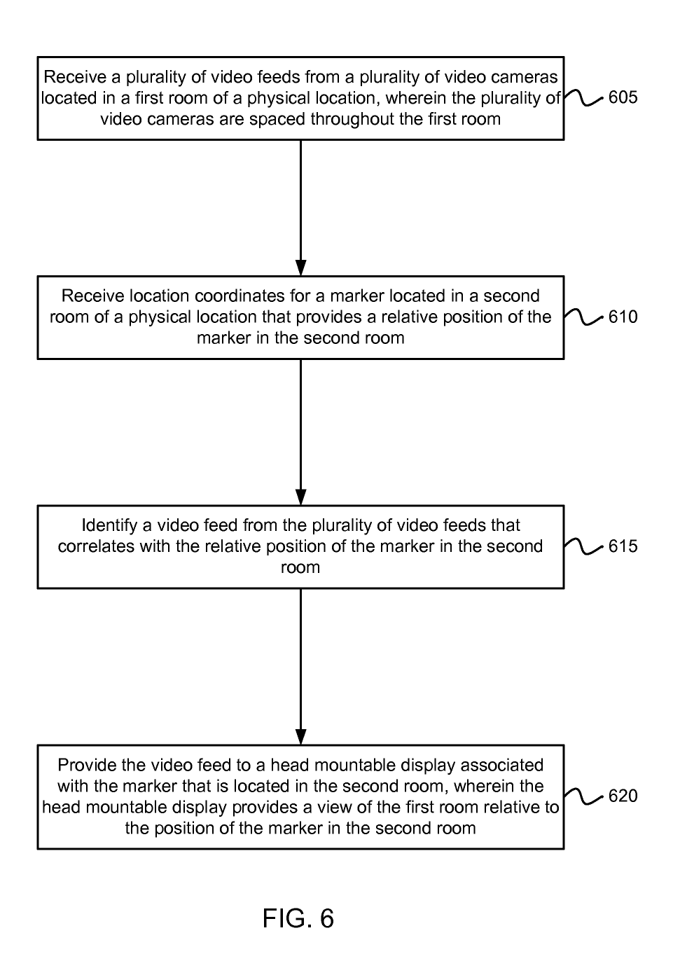

FIG. 6 is a flow diagram illustrating an example method for interaction between two physical rooms. Beginning in block 605, a plurality of video feeds from a plurality of video cameras located in a first room of a physical location may be received by a server where the plurality of video cameras can be spaced throughout the first room. For example, two or more video cameras can be spaced around the perimeter of a first room so that a video feed may be generated that can provide a perspective of the first room to a person who is located in a second room. In one embodiment, the video cameras can be placed at various elevations in the first room thereby providing video feeds from the various elevations. Thus, a video feed may be provided that substantially matches that of a person in a second room. For example, a video feed from a video camera that is at an elevation that is substantially the same as a person who may be sitting in a chair in a second room can be provided, as well as a video feed from a video camera with an elevation that substantially matches that of a person who is standing in a second room.

As in block 610, location coordinates for a marker located in a second room of a physical location can be calculated by a plurality of motion detection cameras and can be received by a server. The location coordinates can provide a relative position of the marker in the second room. For example, a relative position of the marker may be a position in a first room that then is correlated to a position in a second room as described earlier. The plurality of motion detection cameras can be placed around the perimeter of the second room so that as a marker is moved around the second room, the motion detection cameras can track the marker.

In one embodiment, the location coordinates of the marker can be a Cartesian space x, y and z axis distance from a motion detection camera, thus a motion detection camera can provide a longitudinal and latitudinal position of a marker in the second room, as well as an elevation of the marker in the second room. Further, in another embodiment, a direction that a marker may be facing can be determined by the plurality of the motion detection cameras. For example, a marker can be an active marker having an LED that is visible to a motion detection camera. When the LED of the marker is identified by a motion detection camera, a direction that the marker is facing can be determined by the motion detection camera that identifies the marker.

In one embodiment, a marker may be integrated into a head mountable video display as described earlier. In another embodiment, a marker may be attached to a person. For example, the marker may be pinned, clipped or attached using some other method to a person's clothing so that the location of the person can be identified and tracked within the second room. The person can wear a head mountable video display and a video feed can be sent to the head mountable video display that provides the person with a view of the first room from the perspective of the marker that is attached to the person's clothing. Further, a marker can be integrated into an object that a person might wear, such as a wrist band, necklace, headband, belt, etc.

As in block 615, a video feed from the plurality of video feeds that correlates with the relative position of the marker in the second room may be identified. As an illustration, a video feed from a video camera located in the first room that may be located behind a relative position of person in the second room may be identified. Thus, a perspective of the first room may be provided by the video feed that is similar to a perspective of a person associated with the marker in the second room. In one embodiment, at least two video feeds from video cameras in the first room that correlate to the relative position of the marker in the second room can be identified. Using the two video feeds, a virtual video feed that substantially matches a perspective from the marker's vantage point in the second room can be generated. For example, interpolation can be used to perform video processing where intermediate video frames are generated between a first video frame from a first video feed and a second video frame from a second video feed. Thus, using the marker's relative position and direction in the first room, a first video feed and a second video feed can be identified that most closely matches the marker's perspective. The first and the second video feeds can then be used to generate a virtual video feed that may be closer to the perspective of the marker in the second room than what the first video feed or the second video feed could provide individually.

In one embodiment, in addition to a video feed, an audio feed can be received from a microphone in the first room and can be provided to a speaker in the second room. The audio feed may enable a person who is located in the second room to hear others who are located in the first room. In one example, a microphone may be associated with a video camera that is providing a video feed and the audio feed from the microphone can be provided to a person in the second room who is receiving the video feed associated with the audio feed.

As in block 620, the video feed can be provided to a head mountable display associated with the marker that is located in the second room, where the head mountable display provides a view of the first room relative to the position of the marker in the second room. Thus, a person wearing the head mountable display can view the first room from a simulated perspective as though the person where in the first room. For example, a person in a second room can view a first room and others who may be in the first room, and can physically move about the second room where the movements are mimicked in the virtual view of the first room.

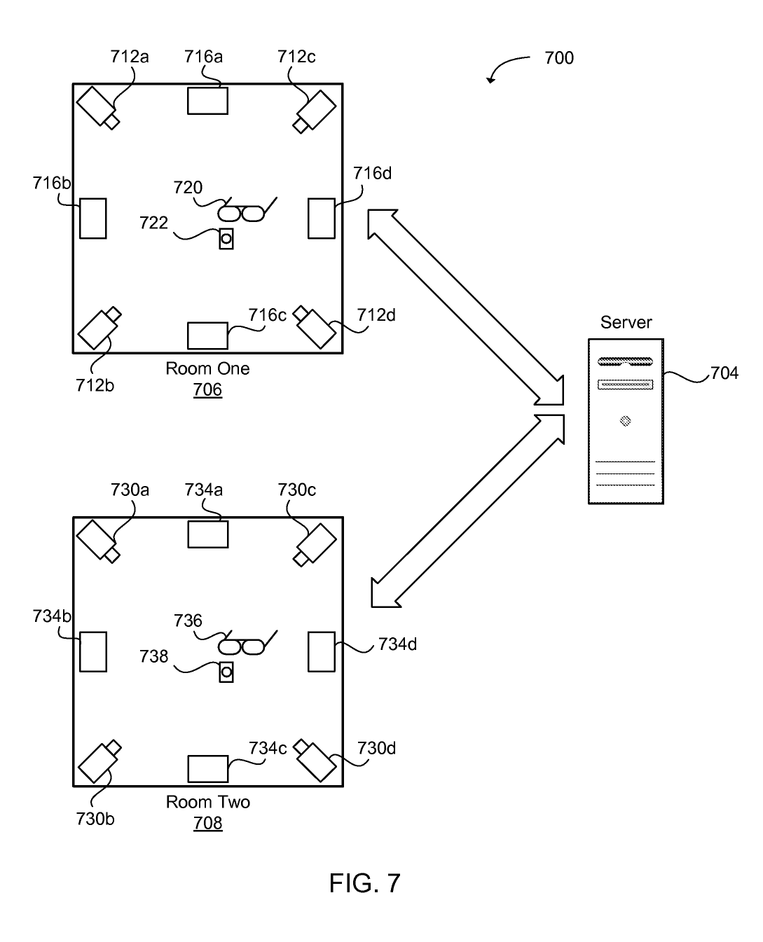

FIG. 7 is a diagram illustrating a method for video interaction between multiple physical locations. As shown in FIG. 7, multiple rooms (i.e., room one 706 and room two 708) can be configured with a number of video cameras and motion detection cameras. For example, room one 706 can contain a plurality of video cameras 712a-d and a plurality of motion detection cameras 716a-d. Room two 708 likewise can contain a plurality of video cameras 703a-d and a plurality of motion detection cameras 734a-d. Each room can provide a video feed from each video camera to a server 704, as well as location coordinates for one or more markers 722 and 738 located in a room. As described herein, the server 704 can provide a video feed, which in some embodiments may be a virtual video feed, to a respective head mountable video display 720 and 736.

As a marker 722 and 738 is moved around a room (e.g., a person associated with the marker walks around the room), one or more video feeds can be determined that most closely correlate to a relative position of the marker 722 and 738. When a video feed may no longer correlate to a marker 722 and 738, the video feed can be terminated and a video feed that closely correlates to the relative position of the marker may be provided to the head mountable video display 720 and 736. In addition, the transition of one video feed to another may be performed at a rate that makes the transition appear seamless to a person wearing the head mountable video display 720 and 736.

In discussing the systems and methods of the present disclosure above, it is also understood that many of the functional units described herein have been labeled as “modules,” in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A system for video interaction between two physical locations, comprising:
a plurality of video cameras configured to generate a video feed of a first room in a physical location;
a plurality of motion detection cameras located in a second room where the plurality of motion detection cameras are configured to detect motion of a marker located in the second room and provide coordinates for the marker;
a head mountable display including a video display that shows the video feed of the first room;
a computing device configured to receive a plurality of video feeds from the plurality of video cameras and to receive coordinates for the marker from the plurality of motion detection cameras, wherein the computing device comprises a processor and a memory device that includes instructions that when executed by the processor, cause the processor to execute;
a tracking module associated with the plurality of motion detection cameras, the tracking module configured to determine a position of the marker in the second room and determine a relative position for the marker in the first room using the coordinates provided by the plurality of motion detection cameras; and
a video module configured to identify a video feed from a video camera of the plurality of video cameras in the first room that correlates to the relative position of the marker in the second room and provide the video feed to the head mountable display.

2. A system as in claim 1, wherein the video module further comprises identifying at least two video feeds from video cameras in the first room that correlate to the relative position of the marker in the second room and interpolating the at least two video feeds rendering a virtual reality view of the first room from a perspective of the marker in the second room.

3. A system as in claim 1, wherein the head mountable display further comprises a display that incorporates the video feed into a transparent display providing a user with a head-up display (HUD).

4. A system as in claim 1, wherein the head mountable display further comprises a head mountable stereoscopic display including a right video display and a left video display to create a near real-time stereoscopic video image from a first video feed and a second video feed, respectively.

5. A system as in claim 4, wherein the right video display and the left video display are positioned at a lower portion of a head mountable device that rests in front of an eye of a user, providing a split view, wherein the first room is visible when looking down and the second room is visible when looking forward.

6. The system as in claim 1, wherein video cameras are spatially separated at a pupillary distance from one another.

7. The system as in claim 1, wherein the video module further comprises identifying at least two camera feeds that are spatially separated at a pupillary distance from one another.

8. A system as in claim 1, wherein the marker is integrated into the head mountable display.

9. A system as in claim 1, further comprising of a microphone configured to generate an audio feed from the first room.

10. A system as in claim 7, wherein a microphone is associated with a video camera.

11. A system as in claim 7, further comprising an audio module configured to identify an audio feed from the microphone in the first room and provide the audio feed to a speaker.

12. A system as in claim 11, wherein the speaker is integrated into the head mountable display.

13. A system as in claim 1, wherein the plurality of video cameras are evenly distributed around a perimeter of the first room.

14. A system as in claim 1, wherein the plurality of video cameras is an array of video cameras.

15. A method for video interaction between multiple physical locations, comprising, under control of one or more computer systems configured with executable instructions:
receiving a plurality of video feeds from a plurality of video cameras located in a first room of a physical location, wherein the plurality of video cameras are spaced throughout the first room;
receiving location coordinates for a marker located in a second room of a physical location that provides a relative position of the marker in the second room;
identifying a video feed from the plurality of video feeds that correlates with the relative position of the marker in the second room; and
providing the video feed to a head mountable display associated with the marker that is located in the second room, wherein the head mountable display provides a view of the first room relative to the position of the marker in the second room.

16. A method as in claim 15, further comprising identifying at least two video feeds from the plurality of video feeds that correlate with the relative position of the marker in the second room and interpolating the at least two video feeds rendering a virtual reality view of the first room from a perspective of the marker.

17. A method as in claim 15, wherein the location coordinates for the marker are provided by a plurality of motion detection cameras that are located around a perimeter of the second room.

18. A method as in claim 15, wherein the location coordinates for a marker further comprise of an x, y, and z axis distance from a motion detection camera.

19. A method as in claim 15, wherein the plurality of video cameras are placed at various elevations within the perimeter of the first room.

20. A method as in claim 15, wherein the marker is an active marker containing at least one light-emitting diode (LED) that is visible to a motion detection camera.

21. A method as in claim 15, wherein the marker is a passive marker that is coated with a retroreflective material that when illuminated by a light source makes the marker visible to a motion detection camera.

22. A method as in claim 15, wherein the marker further comprises a marker that is attached to the person of a user.

23. A method as in claim 15, wherein the marker is located on the head mountable display.

24. A method as in claim 15, further comprising receiving an audio feed from a microphone located in the first room and providing the audio feed to a speaker in the second room.

25. A method for interaction between two physical rooms, comprising, under control of one or more computer systems configured with executable instructions:
receiving video feeds from a first plurality of video cameras located in a first room and a second plurality of video cameras in a second room;
receiving location coordinates for a first marker located in the first room and a second marker located in the second room, the coordinates of a marker providing a relative position of the marker in a room;
determining at least two video feeds from the second room that correlate to the relative position of the first marker and interpolating the two video feeds rendering a virtual reality view of the second room from a perspective of the first marker and providing the virtual reality view to a head mountable display containing the first marker; and
determining at least two video feeds from the first room that correlate to the relative position of the second marker and interpolating the two video feeds rendering a virtual reality view of the first room from a perspective of the second marker and providing the virtual reality view to a head mountable display containing the second marker;

26. A method as in claim 25, further comprising determining at least two video feeds that most closely correlate to a relative position of a marker in a first conference room as the marker is moved around a space of the first conference room.

27. A method as in claim 25, further comprising terminating a video feed and providing a new video feed to an interpolating process at a rate that makes a transition from one video feed to another video feed appear seamless to a user of the head mountable display.
